(19) United States
(12) Patent Application Publication
(10) Pub. No.: US 2014/0337220 A1
(43) Pub. Date: Nov. 13, 2014

(54) SYSTEMS, METHODS, AND COMPUTER PROGRAM PRODUCTS FOR THE RECEIPT OF TRANSACTION OFFERS

(71) Applicant: Jonathan E. Ramaci, Isle of Palms, SC (US)

(72) Inventor: Jonathan E. Ramaci, Isle of Palms, SC (US)

(73) Assignee: BPHAV, LLC, Isle of Palms, SC (US)

(21) Appl. No.: 14/153,913

(22) Filed: Jan. 13, 2014

Related U.S. Application Data
(63) Continuation of application No. 13/893,052, filed on May 13, 2013, now abandoned.

(51) Int. Cl. G06Q 20/40

(52) U.S. Cl. CPC G06Q 20/40
USPC 705/44

(57) ABSTRACT

In general terms, embodiments of the present invention relate to apparatuses, methods, and computer program products for receiving transaction offers. For example, in some embodiments, a method is provided that includes (a) receiving information associated with a transaction; (b) storing, in a memory device, the information associated with a transaction; (c) receiving authentication information from a user to authenticate the user to enter into the transaction; and (d) enabling the user to enter into the transaction by using at least one of a magnetic swipe card writer, bar code display, or fingerprint reader.

### BACKGROUND

Individuals conduct transactions using various payment and authentication methods. For example, to pay for a purchase at a retail store, individuals may use a magnetic swipe card containing credit card or debit card information. As another example, to redeem a coupon or promotion, individuals often use a key fob or piece of paper that includes a bar code indicating information about the coupon.

Despite the use of magnetic swipe cards, bar codes, fingerprint scanners, and other authentication devices, it is still difficult and inefficient to receive an offer for a transaction that involves such technology. For instance, parents may offer to pay for their child's movie tickets, but that may involve loaning their physical credit card to the child. Similarly, one person may offer their customer loyalty card to a friend, but they would still have to provide the actual card to the friend. As a final example, a first co-worker might offer a second co-worker access to a secure document, but the first co-worker may still have to authenticate himself prior to allowing the second co-worker to view the document.

Accordingly, there exists a need for an improved system for the receipt of transaction offers. In particular, there exists a need for an improved system for allowing a first user to receive a transaction offer from a second user, where the proposed transaction requires the use a magnetic swipe card, bar code, fingerprint scanner, or other type of payment or authentication technology.

### BRIEF SUMMARY

Embodiments of the invention relate to apparatuses, methods, and computer program products that allow a user to receive a transaction offer.

In some embodiments, a computing device receives information associated with a transaction. Additionally, the computing device, stores, in a memory device, the information associated with a transaction. Further, the computing device receives authentication information from a user to authenticate the user to enter into the transaction. Lastly, the computing device enables the user to enter into the transaction by using at least one of a magnetic swipe card writer, bar code display, or fingerprint reader.

In some embodiments, receiving the information associated with a transaction comprises receiving the account information of another person. In other embodiments, receiving the information associated with a transaction comprises receiving a coupon for a purchase. In yet some other embodiments, receiving information associated with a transaction comprises receiving an electronic file.

In some embodiments, receiving information associated with a transaction comprises receiving information from a mobile computing device. In other embodiments receiving information associated with a transaction comprises receiving information from a computing system. In yet some other embodiments, receiving information associated with a transaction comprises receiving information from an apparatus operably connected to a mobile computing device.

In some embodiments, receiving authentication information from a user to authenticate the user to enter into the transaction comprises receiving information associated with the user's fingerprint.

In some embodiments, enabling the user to enter into the transaction by using at least one of a magnetic swipe card writer, bar code display, or fingerprint reader comprises writing the information associated with the transaction to a magnetic swipe card. In other embodiments, enabling the user to enter into the transaction by using at least one of a magnetic swipe card writer, bar code display, or fingerprint reader comprises displaying the information associated with the transaction as a bar code. In yet some other embodiments, enabling the user to enter into the transaction by using at least one of a magnetic swipe card writer, bar code display, or fingerprint reader comprises displaying an electronic file after receiving the authentication information via a fingerprint reader.

In some embodiments, enabling the user to enter into the transaction comprises enabling the user to make a purchase. In other embodiments, enabling the user to enter into the transaction comprises enabling the user to redeem a coupon. In other embodiments, enabling the user to enter into the transaction comprises enabling the user to open an access-restricted electronic file. In yet some other embodiments, enabling the user to enter into the transaction comprises enabling the user to enter an access-restricted room.

### BRIEF DESCRIPTION OF THE DRAWINGS

Having thus described embodiments of the invention in general terms, reference will now be made the accompanying drawings, wherein:

FIG. 1 is a flow diagram illustrating a general process flow for receiving transaction offers, in accordance with an embodiment of the invention;

FIG. 2 is a flow diagram illustrating a more detailed process flow for receiving transaction offers, in accordance with an embodiment of the invention;

FIG. 3 is a flow diagram illustrating a more detailed process flow for receiving transaction offers, in accordance with an embodiment of the invention;

FIG. 4 is provides a block diagram illustrating an system and environment configured to perform the receipt of transaction offers, in accordance with an embodiment of the invention;

FIG. 5 is a block diagram illustrating the transaction apparatus of FIG. 4, in accordance with an embodiment of the invention; and

FIG. 6 is a mixed block and flow diagram of a system configured to perform the receipt of transaction offers, in accordance with an embodiment of the invention.

### DETAILED DESCRIPTION OF EMBODIMENTS OF THE INVENTION

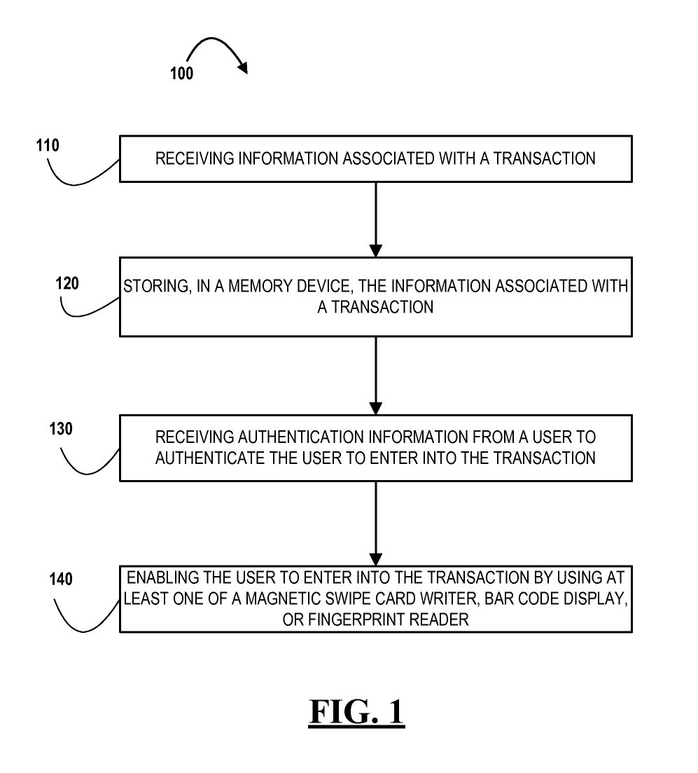

Referring now to FIG. 1, a general process flow 100 is provided for a method of receiving transaction offers. As used herein, the term offer is meant to have one or more of its ordinary meanings, but in other embodiments, that phrase is meant to have one or more ordinary meanings of one or more of the following terms and/or phrases: request, suggestion, proposal, or incentive. Thus a “receiving a transaction offer” would mean receiving an offer, request, suggestion, proposal, or incentive to enter into a transaction. In some embodiments, the process flow 100 is performed by an apparatus (i.e., one or more apparatuses) having hardware and/or software configured to perform one or more portions of the process flow 100. In such embodiments, as represented by block 110, the apparatus is configured to receive information associated with a transaction. As represented by block 120, the apparatus is also configured to store, in a memory device, the information associated with a transaction. In addition, as represented by block 130, the apparatus is configured to receive authentication information from a user to authenticate the user to enter into the transaction. Lastly, as represented by block 140, the apparatus is configured to enable the user to enter into the transaction by using at least one of a magnetic swipe card writer, bar code display, or fingerprint reader.

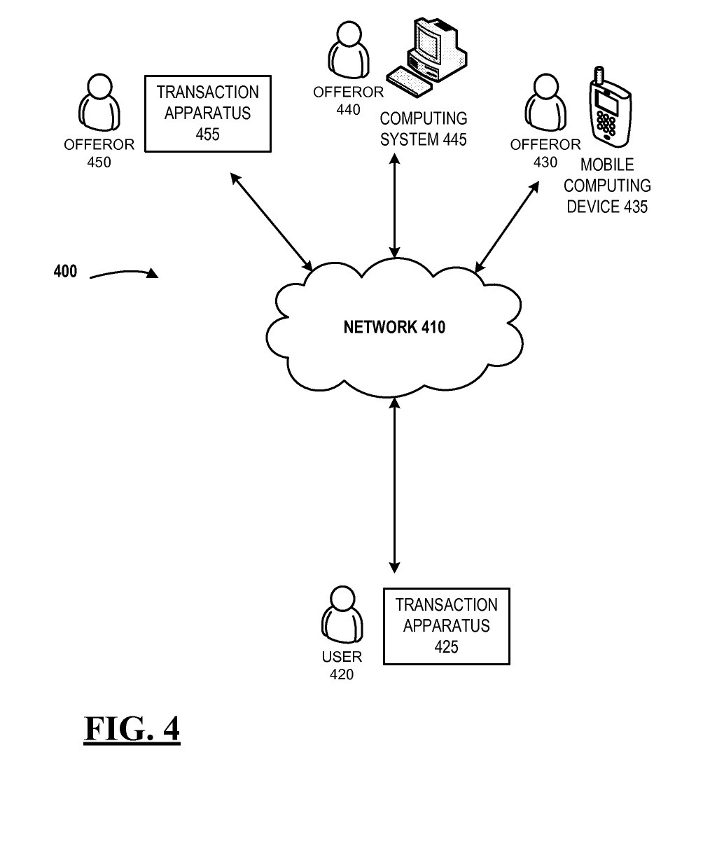

It will also be understood that the apparatus having the process flow 100 can include one or more separate and/or different apparatuses. For example, in some embodiments, a first apparatus (e.g., a mobile computing device) is configured to perform the portions of the process flow 100 represented by blocks 110 and 120, and a second apparatus (e.g., the transaction apparatus 425 described in connection with FIG. 4) is configured to perform the portion of the process flow 100 represented by blocks 130 and 140. Alternatively, in other embodiments, a single apparatus (e.g., the transaction apparatus 425 described in connection with FIG. 4) is configured to perform all of the portions of process flow 100 represented by blocks 110-140. As used herein, the phrase “transaction apparatus” shall refer to an apparatus configured to perform the steps of process flow 100.

Regarding block 110, the term “transaction” may mean any type of financial transaction, including but not limited to, a purchase of goods or services, a sale of goods or services, a transfer of funds, a receipt of funds, any type of loan or other debt and any other type of financial transaction that would be known to one of skill in the art. The term “transaction” may also mean any situation in which a user is allowed to access and/or install an electronic file, including but not limited to an electronic document, image, graphic, sound, executable file, software, firmware, etc. The term “transaction” may also mean any situation in which a user may present identification information and/or other personal information. The term “transaction” may also mean any situation in which a user is allowed to gain access to or use of any object or location, such as entering a restricted building, entering a room, entering a house or starting a car, etc.

The transaction may be a transaction with any person or type of entity. For instance, the transaction may be with a merchant, retailer, company or corporation. Alternatively, the transaction may be with an individual, whether that individual is acting in his/her personal or business capacity.

The information associated with a transaction (also referred to herein as “transaction information”) may be any amount and/or type of information that is associated with a transaction. Where the transaction is a financial transaction, the information associated with a transaction may be any type of information associated with a financial transaction, including, but is not limited to, a checking account number, a savings account number, a bank account number, a debit card number, a credit card number, account expiration dates, account security codes (e.g., CVC), transaction amounts, currency, the names of individuals or entities who are parties to the transaction, rebate codes, coupon codes, promotional details, and the like. Where the transaction is one in which a user is authorized to access and/or install an electronic file, the information associated with a transaction may be any type of information associated with the file, including but not limited to, a copy of the file, firmware, software, the name of the file, the location of the file, security features, passwords, codes necessary to access the file and the like. Where the transaction is one were the user provides identification and/or personal information, the information associated with the transaction may include the user's driver's license, identification card, social security number, healthcare files, insurance cards, and/or other data associated with the user's identification Where the transaction is one in which a user gains access to or use of any object or location, the information associated with a transaction may be any type of information associated with the object or location, including but not limited to, the location information, any passwords or codes needed to access the object or location, and the like.

The apparatus having the process flow 100 receives the transaction information via a network. In some embodiments, the apparatus receives the transaction information via a wireless and/or contactless network. In some embodiments, the apparatus receives the transaction information via second-generation (2G) wireless communication protocols (e.g., IS-136 (time division multiple access (TDMA), GSM (global system for mobile communication), and/or IS-95 (code division multiple access (CDMA)), third-generation (3G) wireless communication protocols (e.g., Universal Mobile Telecommunications System (UMTS), CDMA2000, wideband CDMA (WCDMA) and/or time division-synchronous CDMA (TD-SCDMA)), fourth-generation (4G) wireless communication protocols, and/or the like. In some other embodiments, the apparatus having the process flow 100 is configured to receive the transaction information in accordance with non-cellular communication mechanisms, such as via a wireless local area network (WLAN), global area network (GAN), a wide-area network (WAN), the Internet, and/or other communication/data networks (near-field communication, Bluetooth, infrared networks, etc.). In other embodiments, the apparatus having the process flow 100 receives the transaction information through a hardwired connection.

In some embodiments, the apparatus configured to perform process flow 100 receives the transaction information directly from a mobile computing device, including but not limited to a mobile phone, personal digital assistant, gaming device, etc. In other embodiments, the apparatus configured to perform process flow 100 receives the transaction information directly from a computer system, such as a desktop computer, laptop/portable computer, or tablet computer. In other embodiments, the apparatus configured to perform process flow 100 receives the transaction information directly from another transaction apparatus, such as transaction apparatus 450 described in connection with FIG. 4. The device from which the apparatus configured to perform process flow 100 receives the transaction information may be maintained by any individual or entity, including but not limited to, merchants, financial institutions, retailers, friends, family members, other individuals, or any other individual or entity that is acting on behalf of any of the foregoing.

In other embodiments, the information associated with a transaction may initially sent to a first device, such as a mobile computing device or computing system, and the apparatus configured to perform process flow 100 may then receive the transaction information from that first device. The apparatus configured to perform process flow 100 may be communicably connected (e.g., hardwired communication, wireless communication, etc.) to such first device.

In some embodiments, the apparatus configured to perform process flow 100 receives the information associated with a transaction when the apparatus is at a certain location. For example, the apparatus may receive an electronic coupon that can be redeemed at a certain store when an individual carrying the transaction apparatus walks past such store. In such embodiments, the transaction information may be automatically sent to potential visitors of the store at a certain rate (e.g., one person per minute) and that rate could decrease as more visitors enter the store. Alternatively, the store could initially send out transaction information that includes an offer with a great incentive to visit the store (e.g., 50% off, but one get one free, etc.) and then, as more visitors enter the store, lesser incentives could be sent to other individuals (e.g., 10% off, buy three get one free, etc.). In such embodiments, the receipt of transaction information could be used to promote certain consumer behavior (e.g., drive customers to a store, drive the sales of certain products, etc.). In another embodiment, a store could send a loyalty card to the transaction apparatus of a store visitor when it determines that the visitor does not already have a loyalty card for the store.

The term “determine,” in some embodiments, is meant to have one or more of its ordinary meanings (i.e., its ordinary dictionary definition(s)), but in other embodiments, that term is meant to have one or more ordinary meanings of one or more of the following terms: decide, conclude, verify, ascertain, find, discover, learn, calculate, observe, read, and/or the like.

In other embodiments, the apparatus configured to perform process flow 100 randomly receives the information associated with a transaction (i.e., randomly receives a store coupon, etc.) or the apparatus configured to perform process flow 100 receives the information based upon prior transaction (i.e., receiving a gift certificate for ice cream after making prior ice cream purchases). In some embodiments, the apparatus configured to perform process flow 100 contains an artificial intelligence (“AI”) algorithm that functions to predict and anticipate (i) the retailer or merchant from which the user will make his/her next purchase or (ii) the type of product that the user will purchase next. In such embodiments, the apparatus configured to perform process flow 100 may communicate with a merchant/retailer and notify the merchant/retailer that it should send transaction information to the user so that the user receives a transaction offer through the transaction apparatus that is relevant to the user's predicted next purchase.

The transaction apparatus may receive transaction information when an individual or entity (a “sender”) chooses to send such transaction information through the use of a mobile computing device, computer system, or transaction apparatus 450, which is described in connection with FIG. 4. In such embodiments, the sender may choose to send the transaction information to the apparatus configured to perform process flow 100 in any number of ways, including but not limited to: (i) entering the name, email address, user name, credit card number, phone number, bank account number or any other identifying information of the user of the transaction apparatus; (ii) entering the unique identifying number (e.g., MAC address) of the transaction apparatus; or (iii) or selecting the transaction apparatus from a list of devices that are communicably coupled to a mobile computing device, computer system or transaction apparatus 450 (i.e., identifying all devices on a Bluetooth network, WiFi network, LAN, NFC network, infrared network, etc.). In certain embodiments, including when the sender is sending transaction information through the use of transaction apparatus 450, the sender may be required to provide authentication data prior to sending the transaction information. In some of such embodiments, the sender may be required to use the built in functionality of transaction apparatus 450 (e.g., biometric scanner, fingerprint reader, retina scanner, voice recognition, etc.) to provide the authentication data.

In some embodiments, the apparatus configured to perform process flow 100 receives encrypted transaction information and in other embodiments, the transaction information is not encrypted.

As described above in relation to the previously mentioned embodiments, merchants and businesses may send transaction information to a transaction apparatus to drive business and affect sales. Businesses could send transaction information to a transaction apparatus using any of the aforementioned techniques (i.e., based on location a transaction apparatus, based on individual's transaction history, randomly, sent to specific users, etc.) in order to drive traffic to their businesses. For instance, in one example, a restaurant could randomly send coupons to all transaction apparatus users who have previously made purchases at the restaurant, where the coupon provides a discount for that day's lunch only.

Alternatively, in some embodiments, the user of the transaction apparatus could elicit transaction information from third parties, such as third party businesses. The types of transaction information that the user elicits could be random or it could be targeted based on the location of the user. For instance, the user of the transaction apparatus could be located at Times Square in New York City. Using any type of command that would be known to one of skill in the art (e.g., interacting with a touch screen, voice commands, etc.) the user could elicit transaction information from businesses near his location. Based upon the user's location information (e.g., GPS coordinates, cell tower triangulation, etc.), the transaction apparatus could receive transaction information from nearby businesses, such as coupons, gift cards, promotions, etc. In this embodiment, the user can use the transaction apparatus to learn about sales promotions and other retail opportunities near his physical location.

In some embodiments, the transaction apparatus could be configured to receive information about the user's preferences, such as favorite stores, interests, hobbies, or any other information that might be relevant to the types of coupons, gift cards, promotions that the user wishes to receive via his transaction apparatus. Thus, in such embodiments, when the user elicits transaction information from third parties, the transaction apparatus will only receive transaction information that is relevant to the user's preferences. Further, the transaction apparatus could use these preferences to block certain types of transaction information that is sent to the user's transaction apparatus. Thus, if the user adds a preference that he is not interested in offers from a certain retailer, the transaction apparatus would block the receipt of any transaction information from that retailer.

Regarding block 120, the apparatus configured to perform process flow 100 stores the information associated with a transaction in a memory device. In some embodiments of the invention, the memory device is a part of the apparatus configured to perform process flow 100. In other embodiments, the apparatus configured to perform process flow 100 stores the information associated with a transaction in some other memory device, including a memory device contained in a mobile computing device or computing system, which may be attached to or located remotely from the apparatus. In some embodiments, the apparatus configured to perform process flow 100 may store the information associated with a transaction in an encrypted, or protected fashion, such that an individual seeking to access such information authenticates himself or herself to the apparatus.

Regarding block 130, the term “authentication information” means any amount or type of information that a user may use to authenticate himself or herself. Authentication information may include, but is not limited to, passwords, challenge question answers, biometric information including, but not limited to, voice patterns (i.e., for us in connection with voice recognition technology), retina patterns (i.e., for use in connection with retina scan technology), or fingerprints (i.e., for use in connection with fingerprint scanning technology). The apparatus configured to perform process flow 100 may receive the authentication information through any means or functionality, including but not limited to, through the use of a keyboard, keypad, touchscreen display, biometric scanner, retina scanner, microphone, camera, fingerprint scanner. Such functionality may be included in the apparatus that is configured to perform process flow 100 or the apparatus may be attached or communicably connected to a device that has such functionality (e.g., a mobile computing device, a computing system, etc.). Although not depicted in connection with block 130, the apparatus configured to perform process flow 100 compares the authentication information to user data to determine whether the user is authenticated. If the authentication information matches the user data (e.g., in whole, in part, or above a certain confidence threshold, etc.) then the user is authenticated. If the authentication information does not match the user data, then the user is not authenticated. The user data may be stored in a memory device of the apparatus configured to perform process flow 100 or any other memory device to which such apparatus is communicably coupled.

Regarding block 140, the apparatus configured to perform process flow 100 enables the user to enter into the transaction if the user provides the correct authentication information at block 130. If the user does not provide the correct authentication information at block 130, then the user is not allowed to enter into the transaction.

The apparatus configured to perform process flow 100 enables the user to enter into the transaction by using at least one of a magnetic swipe card, bar code reader, or fingerprint reader. For example, if the transaction requires the use of a magnetic swipe card (e.g., purchasing goods at a check-out terminal, accessing a secure location, using a secure object), the apparatus configured to perform process flow 100 may write all or a portion of the transaction information to the magnetic swipe card such that it can be used in connection with the transaction. As an another example, if the transaction requires the use of a bar code (e.g., redeeming a coupon), the apparatus configured to perform process flow 100 may display all or a portion of the transaction information as a bar code, using e-ink technology or any other technology known to one skilled in the art. As yet another example, if the transaction involves accessing an electronic file, the apparatus configured to perform process flow 100 may provide the user with access to the file only after the user authenticates his or her identity using a fingerprint reader. In some embodiments, the use of the fingerprint reader to enable the user to enter into the transaction may occur simultaneously with the step described in connection with block 130. Alternatively, in other embodiments, the use of the fingerprint reader to enable the user to enter into the transaction may occur after the step described in connection with block 130.

Although not depicted in FIG. 1, in some embodiments, process flow 100 may include the optional step of receiving preferences associated with the transaction. As used herein, the phrase “preferences associated with the transaction” means any type of preferences that describe, limit, condition a transaction or otherwise place parameters on the transaction. For example, the preferences associated with the transaction may dictate that a user can only use transaction information in connection with purchases at a certain store (e.g., Grocery Store X, Hardware Store Y, etc.). As another example, the preferences associated with the transaction may dictate that a user can only use transaction information in connection with purchases at a certain type of store (e.g., bookstores, coffee shops, etc.). As another example, the preferences associated with the transaction may dictate that a user cannot use transaction information in connection with purchases at a certain type of store (e.g., liquor stores, gun stores, etc.). As another example, the preferences associated with the transaction may dictate that a user can only use transaction information to enter into purchases of a certain amount (e.g., less than $100, etc.). As yet another example, the preferences associated with the transaction may dictate that the user can only enter into the transaction (i.e., redeem a coupon, use a gift card, etc.) within a certain limited time period. As one of skill in the art will appreciate, the preferences associated with the transaction may place any type of limitation, restriction, condition, etc. on the user's ability to use the transaction information in connection with a transaction. In some embodiments, if the user attempts to use to enter into a transaction that is not in accordance with the transaction preferences, then the transaction will be denied. For example, the transaction preferences may require that the user only enter into transactions less than $100. To the extent the user enters into a transaction greater than $100, the transaction may be denied.

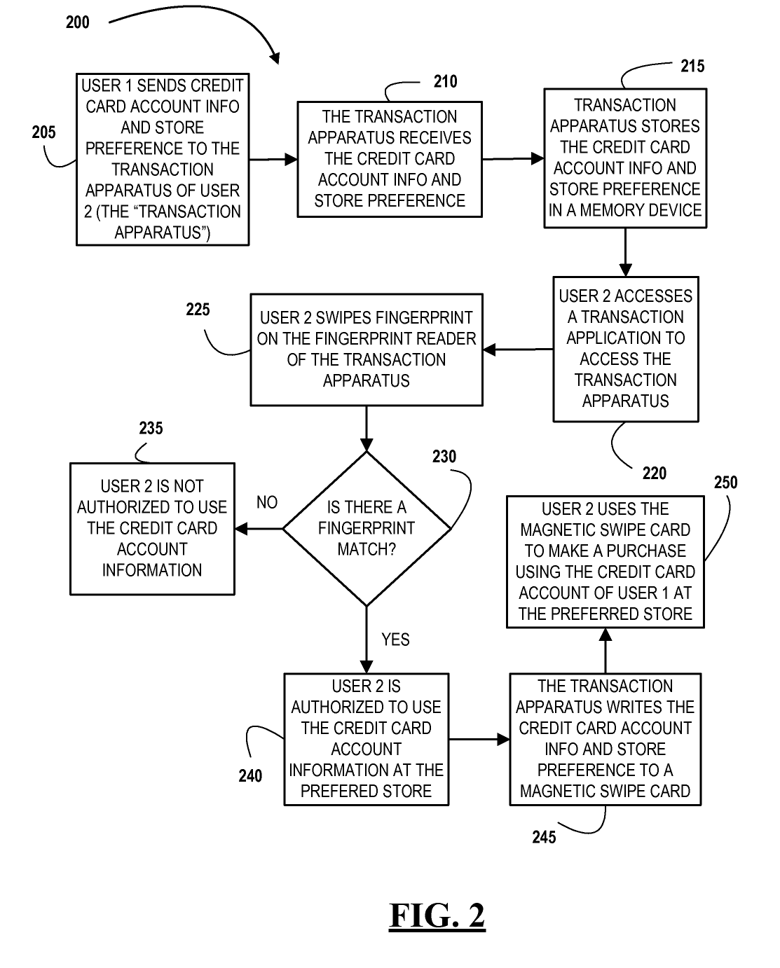

Referring now to FIG. 2, a more-detailed process flow 200 for receipt of transaction offers is provided, in accordance with an embodiment of the present invention. In some embodiments, one or more portions of the process flow 200 are performed by an apparatus having hardware and/or software configured to perform one or more portions of the process flow 200. In some of these embodiments, the apparatus configured to perform the process flow 100 is also configured to perform the process flow 200. As such, it will be understood that the process flow 200 illustrated in FIG. 2 represents an example embodiment of the process flow 100 described in connection with FIG. 1. Specifically, FIG. 2 details a process-flow in which one individual (i.e., User 1) wants to authorize a second individual (i.e., User 2) to use User 1's credit card account to make a purchase at Clothing Store X (i.e., the “Preferred Store”) using a transaction apparatus.

Referring to block 205, User 1 sends credit card account information and the store preference (i.e., only make a transaction at Clothing Store X) to the transaction apparatus of User 2. In this embodiment, User 1 also has his own transaction apparatus and uses such device to send the information to the transaction apparatus of User 2. In some embodiments, User 1 may send the information to User 2's transaction apparatus by inputting the unique identifying number of User 2's transaction apparatus. In other embodiments, User 1 may input any unique alphanumeric identifier that is associated with User 2 (e.g., email address, user name, phone number, etc.). In this embodiment, User 1 sends the information to User 2 via a cellular network; however, in other embodiments of the invention, any other type of communication network may be used. At block 210, the transaction apparatus of User 2 receives the credit card account information and store preference via the cellular network and at block 215, the received information is stored in a memory device. In this embodiment, the transaction apparatus of User 2 stores the information in a memory device comprising the transaction apparatus, but in other embodiment, the transaction device may store the information to any memory device to which it is communicably coupled (via a hardwired connection or wireless communication network).

At block 220, User 2 accesses a transaction application to access the transaction apparatus. This application allows User 2 to access the functionality of the transaction apparatus (as described in connection with FIG. 1). The transaction application may be a mobile application or any other type of executable software that is known to one of skill in the art. In this embodiment, the transaction application is stored on a memory device housed in the transaction apparatus. However, in other embodiments the transaction application may be stored in a separate memory device, such a memory device of a mobile device (in embodiments where the transaction apparatus is connected to a mobile device).

At block 225, User 2 swipes his fingerprint on the fingerprint reader of his transaction apparatus in order to authenticate himself. At block 230, the transaction apparatus then compares the information about the fingerprint oft User 2 to stored data to determine whether there is a match. If there is a match, then User 2 is authorized to use the transaction apparatus and enter into a transaction using the credit card of User 1. In this embodiment, User 2 initially swiped his fingerprint when he first acquired the transaction apparatus. Thus, the transaction apparatus has stored a record of what User 2's fingerprint looks like and uses such user data to subsequently authenticate User 2. This user data is stored in the memory device of the transaction apparatus. However, in other embodiments, it could be stored in any other memory device that is communicable coupled (via a hardwired connection or wireless communication network) to the transaction apparatus.

At block 230, if there is not a match between the fingerprint of User 2 and the user data, then at block 235, User 2 is not authorized to use the credit card account information of User 1 in making a purchase at Clothing Store X. In some embodiments of the invention, the transaction apparatus of User 2 may delete the information it received at block 210 after one or more failed authentication attempts at block 225.

At block 230, if there is a match between the fingerprint of User 2 and the user data, then at block 240, User 2 is authorized to use the credit card account information at Clothing Store X. Thus at block 245, the transaction apparatus writes the credit card information that it received at block 210, as well as the store preference, to a blank or reusable magnetic swipe card. The transaction apparatus performs this functionality using a magnetic card writer, which is contained in the transaction apparatus or hardwired thereto.

At block 250, User 2 uses the magnetic swipe card (which was written at block 245), to make a purchase at Clothing Store X. User 2 uses the magnetic wipe card (which contains User 1's credit card account information) just like any other type of debit, credit, banking, etc. card. The purchase that User 2 makes at Clothing Store X will be directed to User 1's credit card account. Although not depicted in FIG. 2, if User 2 attempts to use the magnetic swipe card to make a purchase at a store other than Clothing Store X, the purchase will be denied because the store preference, which is also stored on the magnetic swipe card, will prevent User 2 from making purchases at stores that have not been authorized by User 1.

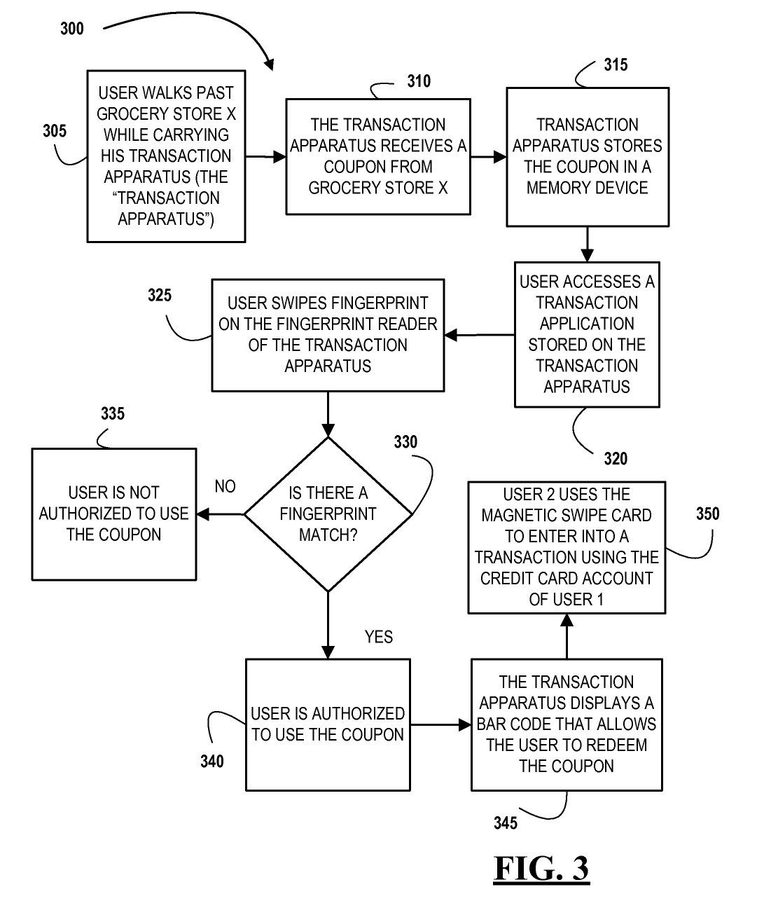

Referring now to FIG. 3, a more-detailed process flow 300 for receipt of transaction offers is provided, in accordance with an embodiment of the present invention. In some embodiments, one or more portions of the process flow 300 are performed by an apparatus having hardware and/or software configured to perform one or more portions of the process flow 300. In some of these embodiments, the apparatus configured to perform the process flow 100 is also configured to perform the process flow 300. As such, it will be understood that the process flow 300 illustrated in FIG. 1 represents an example embodiment of the process flow 100 described in connection with FIG. 1. Specifically, FIG. 3 details a process-flow in which one individual (i.e., the “User”) receives a coupon via a transaction apparatus towards a purchase at a retailer (i.e., “Grocery Store X”).

Referring to block 305, the User walks past Grocery Store X while carrying his transaction apparatus. At block 310, the transaction apparatus receives a coupon from Grocery Store X. In this embodiment of the invention, a computer system associated with Grocery Store X sends the coupon the User's transaction device via a cellular network. Grocery Store X sent the coupon to the User's transaction device because it determined that the User was physically located near Grocery Store X based on GPS information. In this embodiment of the invention, the GPS information is transmitted by the transaction device, but in other embodiments of the invention, the GPS information could be transmitted by another device that is communicably coupled to the transaction device (via a hardwired connection or wireless communication network), such as a mobile computing device. As one of skill in the art will appreciate, the step described at block 310 may use any type of functionality to determine that the User is located physically near Grocery Store X.

Although in this embodiment of the invention, Grocery Store X sends a coupon to the User, the Grocery Store may send any other type of transaction information to the User, such as a gift certificate, credit, promotion, contest entry, etc. that may be redeemed by the User through the use of the transaction apparatus.

At block 315, the received coupon is stored in a memory device. In this embodiment, the transaction apparatus of User 2 stores the information in a memory device comprising the transaction apparatus, but in other embodiment, the transaction device may store the information to any memory device to which it is communicably coupled (via a hardwired connection or wireless communication network).

At block 320, User accesses a transaction application to access the transaction apparatus. This application allows User to access the functionality of the transaction application (as described in connection with FIG. 1). The transaction application may be a mobile application or any other type of executable software that is known to one of skill in the art. In this embodiment, the transaction application is stored on a memory device housed in the transaction apparatus. However, in other embodiments the transaction application may be stored in a separate memory device, such a memory device of a mobile device (in embodiments where the transaction apparatus is connected to a mobile device).

At block 325, User swipes his fingerprint on the fingerprint reader of his transaction apparatus in order to authenticate himself. At block 330, the transaction apparatus then compares the information about the fingerprint about User to stored data to determine whether there is a match. If there is a match, then User is authorized to use the transaction apparatus and enter into a transaction using the coupon sent from Grocery Store X. In this embodiment, User initially swiped his fingerprint when he first acquired the transaction apparatus. Thus, the transaction apparatus has stored a record of what User's fingerprint looks like and uses such user data to subsequently authenticate User. This user data is stored in the memory device of the transaction apparatus. However, in other embodiments, it could be stored in any other memory device that is communicable coupled (via a hardwired connection or wireless communication network) to the transaction apparatus.

At block 330, if there is not a match between the fingerprint of User and the user data, then at block 335, the User is not authorized to use the coupon in connection with a purchase at Grocery Store X. In some embodiments of the invention, the transaction apparatus of User may delete the coupon it received at block 310 after one or more failed authentication attempts at block 325.

At block 330, if there is a match between the fingerprint of User and the user data, then at block 340, User is authorized to use the coupon in connection with a transaction at Grocery Store X. Thus at block 345, the transaction apparatus displays a bar code that allows the user to redeem the coupon at Grocery Store X. The transaction apparatus performs this functionality using an e-ink display, which is contained in the transaction apparatus and displays a bar code.

At block 350, User uses the transaction apparatus to display the bar code to redeem the coupon at Grocery Store X. In this embodiment, User uses the bar code (which contains information about the coupon) just like any other type of bar code that may be contained on a physical coupon or loyalty card.

FIG. 4 provides a block diagram illustrating a system and environment 400 for receipt of transaction offers, in accordance with an embodiment of the invention. As illustrated in FIG. 4, the environment 400 includes a User 420 that is associated with a transaction apparatus 425, an Offeror 430 that is associated with mobile computing device 435, an Offeror 440 that is associated with a computing system 445, and an Offeror 450 that is associated with a transaction apparatus 455, and a network 410. User 420, through the user of transaction apparatus 425, may receive transaction information from one or all of Offeror 430, Offeror 440, and Offeror 450 in accordance with the process flow describe in connection with FIG. 1. Transaction apparatus 425, mobile computing device 435, computing system 445, and transaction apparatus 455 communicate via network 410.

The network 410 may include a local area network (LAN), a wide area network (WAN), a global area network (GAN), near field communication network, infrared network, Bluetooth network or any other type of communications network or protocol. In some embodiments, network 410 may comprise the Internet. In addition, network 410 may include first, second, third, and/or fourth-generation cellular communication networks and/or the like. For example, the network 410 may include second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The network 410 may provide for wired, wireless, or a combination of wired and wireless communication between devices on the network.

Mobile computing device 435 and computing system 445 each generally include a processor communicably coupled to such devices as a memory device and a communication interface. Mobile computing device 435 and computing system 445 may include any other hardware or be configured in any other way that is known to one of skill in the art.

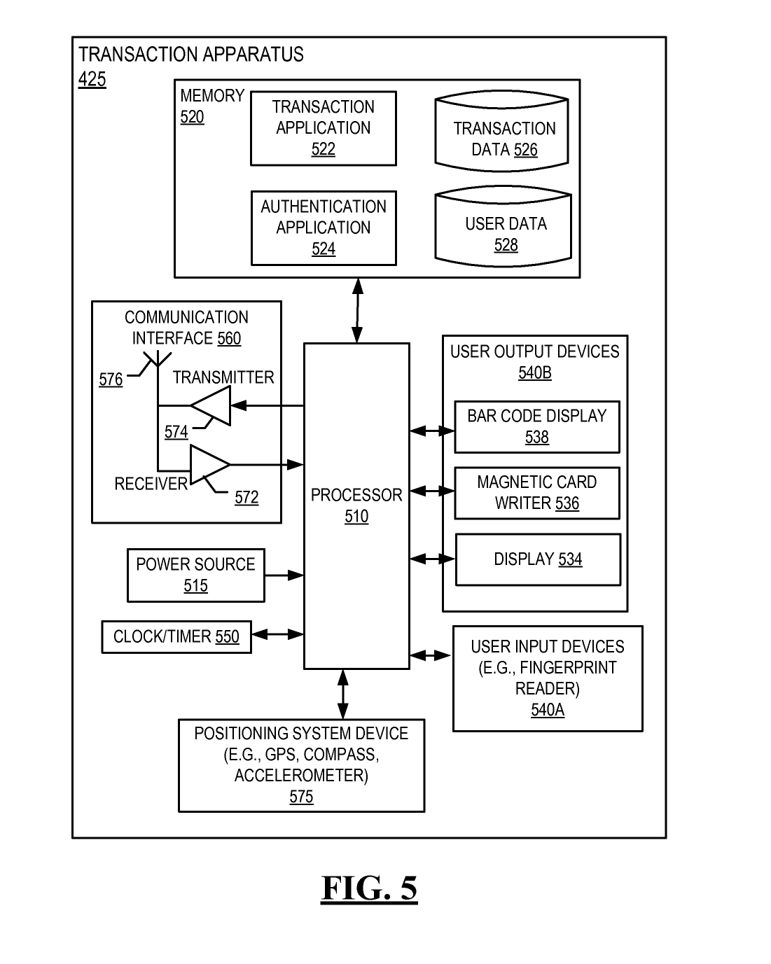

A detailed description of an embodiment of transaction apparatus 425 is provided in FIG. 5. However, it should be understood that in some embodiments, transaction apparatus 425 is a standalone apparatus. In other embodiments, transaction apparatus is connected to another device, such as a mobile computing device or computing system. In some of such embodiments, transaction apparatus may be a mobile computing device accessory, such as a case or other type of attachment that is communicably coupled to the mobile computing device via a hardwired connection or wireless communication network. In such embodiments, all or portions of the components of transaction apparatus 425 (as depicted in FIG. 5) may be contained in the device to which transaction apparatus 425 is communicably coupled. Transaction apparatus 455 has the same design, components, and functionality as transaction apparatus 425.

FIG. 5 is a detailed illustration of transaction apparatus 425 according to one embodiment of the invention. Specifically, FIG. 5 depicts an embodiment of transaction apparatus 425 in which it is a standalone apparatus. As depicted in FIG. 5, the transaction apparatus 425 may generally include a processor 510 communicably coupled to such devices as a memory 520, user output devices 540B, user input devices 540A, a communication interface 560, a power source 515, a clock or other timer 550, and positioning system device 575.

As illustrated in FIG. 5, processor 510 may be configured to use the communication interface 560 to communicate with one or more other devices on a network. In this regard, the communication interface 560 may include an antenna 576 operatively coupled to a transmitter 574 and a receiver 572 (together a “transceiver”). The processor 510 may be configured to provide signals to and receive signals from the transmitter 574 and the receiver 572, respectively. The signals may include signaling information in accordance with the air interface standard of the applicable cellular system of the wireless telephone network that may be part of the network. In this regard, transaction apparatus 425 may be configured to operate with one or more air interface standards, communication protocols, modulation types, and access types. In some embodiments, the mobile device 312 may be configured to operate in accordance with second-generation (2G) wireless communication protocols, third-generation (3G) wireless communication protocols, and/or fourth-generation (4G) wireless communication protocols, and/or the like. The transaction apparatus 425 may also be configured to operate in accordance with non-cellular communication mechanisms, such as via a WLAN, WAN, GAN, the Internet and/or other communication/data networks.

As described above, the transaction apparatus 425 may have a user interface 540 that includes user output devices 540B and/or user input devices 540A. The user output devices 540B may include a display 534 (e.g., a liquid crystal display (LCD) or the like), magnetic card writer 536, and bar code display 538 (e.g., e-ink writer or the like) which are operatively coupled to the processor 510. The user input devices 540A, which may allow the transaction apparatus 425 to receive data from the user 420, may include a fingerprint reader, as well as any of a number of devices allowing the transaction apparatus 425 to receive data from a user, such as a keypad, keyboard, touch-screen, touchpad, microphone, mouse, joystick, other pointer device, button, soft key, and/or other input device(s).

The transaction apparatus 425 may further include a power source 515. Generally, the power source 515 is a device that supplies electrical energy to an electrical load. In one embodiment, the power source 515 may convert a form of energy such as solar energy, chemical energy, mechanical energy, etc. to electrical energy. Generally, the power source 515 in the transaction apparatus 425 may be a battery, such as a lithium battery, a nickel-metal hydride battery, or the like, that is used for powering various circuits, e.g., the transceiver circuit, and other devices that are used to operate the transaction apparatus 425. Alternatively, the power source 515 may be a power adapter that can connect a power supply from a power outlet to the transaction apparatus 425. In such embodiments, a power adapter may be classified as a power source “in” the mobile device.

The transaction apparatus 425 may also include a memory 520 operatively coupled to the processor 510. As used herein, memory may include any computer readable medium configured to store data, code, or other information. The memory 520 may include volatile memory, such as volatile Random Access Memory (RAM) including a cache area for the temporary storage of data. The memory 520 may also include non-volatile memory, which can be embedded and/or may be removable. The non-volatile memory may additionally or alternatively include an electrically erasable programmable read-only memory (EEPROM), flash memory or the like.

The memory 520 may store any of a number of applications or programs, which include computer-executable instructions/code executed by the processor 510 to implement the functions of the transaction apparatus 425 described herein. For example, the memory 520 may include such applications as an authentication application 524 and transaction application 522. Transaction application 522 may comprise computer readable code that when executed by processor 510 cause transaction apparatus 425 to perform the functions described in connection with blocks 110, 120, and 140. Authentication application 524 may comprise computer readable code that when executed by processor 510 cause transaction apparatus 425 to perform the functions described in connection with block 130. As one of skill in the art will appreciate, in some embodiments, the functions of transaction application 522 and authentication application 524 may be combined into a single application comprised of computer readable code.

Memory 520 may also store any amount of data, which may be accessed by any of the applications stored on memory 520 and/or processor 510. For example, memory 520 may include such data as transaction data 526 and user data 528. Transaction data 526 may comprise the information associated with a transaction that is received by the transaction apparatus 425 at block 110 of FIG. 1. User data 528 may comprise the information that is accessed by the transaction apparatus at block 130 of FIG. 1 to determine whether a user's authentication information is a match.

While FIG. 5 depicts an embodiment of transaction apparatus 425 in which transaction apparatus 425 is a standalone apparatus, in other embodiments, transaction apparatus 425 is connected to another device, such as a mobile computing device or computing system. In some of such embodiments, transaction apparatus 425 may be a mobile computing device accessory, such as a case or other type of attachment that is communicably coupled to the mobile computing device via a hardwired connection or wireless network connection. In such embodiments, all or portions of the components of transaction apparatus 425 (as depicted in FIG. 5) may be contained in the device to which transaction apparatus 425 is communicably coupled.

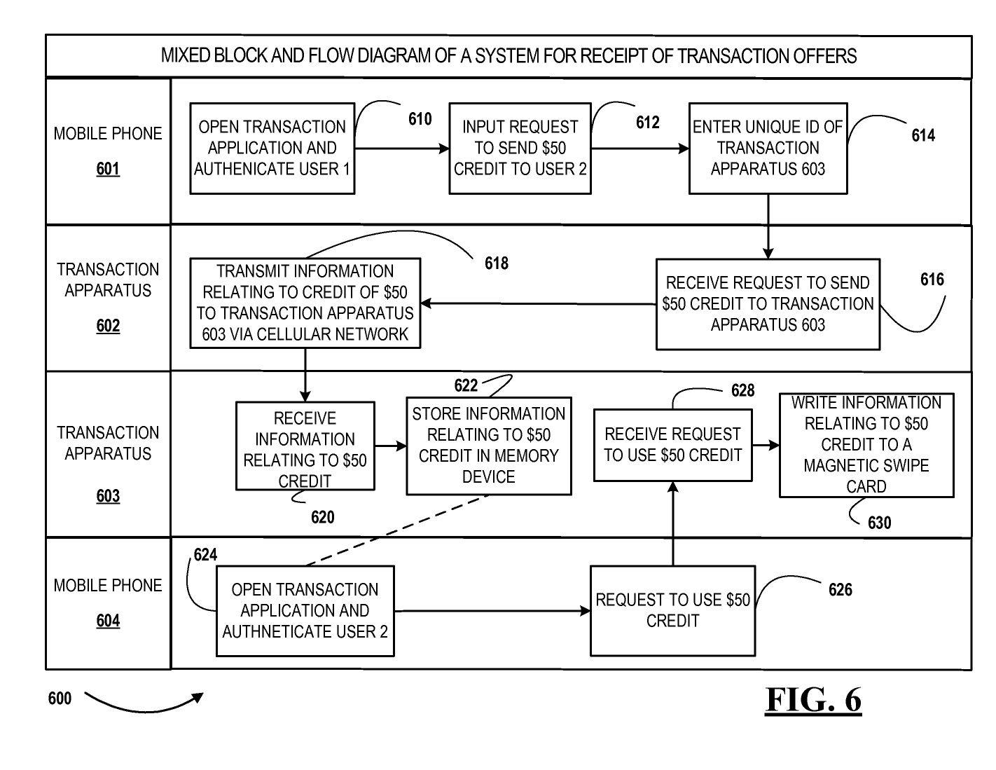

Referring now to FIG. 6, a mixed block and flow diagram of a system 600 is provided for receiving transaction offers. It will be understood that the system 600 illustrated in FIG. 6 represents an embodiment of the process flow 100 described in connection with FIG. 1. In general terms, FIG. 6 illustrates an embodiment of the invention where a User 1 sends a $50 dollar credit to User 2 using an embodiment of the method of the present invention. In this embodiment, User 1 uses a transaction apparatus 602, which is connected to mobile phone 601 and User 2 uses transaction apparatus 603, which is connected to mobile phone 604.

Transaction apparatus 602 and transaction apparatus 603 are embodiments of transaction apparatus 425, in which some of the components depicted in FIG. 5 are contained in mobile phone 601 and mobile phone 604, respectively. Thus, in this embodiment, transaction apparatus 602 and mobile phone 601 are communicably coupled together via a hardwired connection and transaction apparatus 603 and mobile phone 604 are communicably coupled together via a hardwired connection. In accordance with some embodiments, mobile phone 601, transaction apparatus 602, transaction apparatus 603, and mobile phone 604 are operably and selectively connected to each over via a cellular network.

As depicted in block 610, User 1 opens a transaction application, which is stored in the memory of mobile phone 601, to access the functionality of transaction apparatus 602. Further, at block 610, User 1 swipes his fingerprint on the fingerprint scanner of transaction apparatus 602 to authenticate himself to allow access to the functionality of transaction apparatus 602.

At block 612, User 1 inputs a request to send a $50 credit to User 2. In this embodiment, User 1 uses the touchscreen of mobile phone 601 to input this request. User 1 further indicates the financial account from which he wishes to make the $50 dollar credit. For example, User 1 could indicate that the $50 credit should come from his checking account or any other account for which he is authorized to use (e.g., credit card account, saving account, etc.)

At block 614, after inputting the request to send a $50 dollar credit to User 2, User 1 inputs the unique Id of transaction apparatus 603. By entering this unique ID, User 1 will properly transmit the transaction information relating to the $50 credit to transaction apparatus 603.

At block 616, transaction apparatus 602 receives the request to send the $50 credit from mobile phone 601. In this embodiment, transaction apparatus 602 is physically connected to mobile phone 601 and receives this information via a hardwired connection. At block 616, transaction apparatus receives all of the information relating to the $50 credit (i.e., the unique ID of transaction apparatus 603, the account from which the $50 credit is coming, etc.). After receiving this information from mobile phone 601, at block 618, transaction apparatus 602 transmits the information relating to the $50 credit to transaction apparatus 603 via a cellular network. However, in other embodiments of the invention, the information may be sent to transaction apparatus 603 directly by mobile phone 601 after the completion of the functionality described at block 614.

At block 620, transaction apparatus 603 (which is associated with User 2) receives the information relating to the $50 credit. In this embodiment, the information is directly sent to transaction apparatus 603, however, in other embodiments, the information could be received first by mobile phone 604 and then transmitted to transaction apparatus 603 via a hardwired connection (since mobile phone 604 and transaction apparatus 603 are connected to each other). At block 622, the information relating to the $50 credit is stored in a memory device. In this embodiment, the information relating to the $50 credit is securely stored in a memory device of transaction apparatus 603. However, in other embodiments, the information relating to the $50 credit is securely stored in a memory device of mobile phone 604.

The dashed line between block 622 and block 624 indicates that block 624 may occur anytime subsequent to the completion of block 622. At block 624, User 2 opens a transaction application, which is stored in the memory of mobile phone 604, to access the functionality of transaction apparatus 603. Further, at block 624, User 2 swipes his fingerprint on the fingerprint scanner of transaction apparatus 603 to authenticate himself to allow access to the functionality of transaction apparatus 603 in order to use the $50 credit that was sent from User 1.

At block 626, User 2 inputs a request to use the $50 credit sent by User 1. In this embodiment, User 2 uses the touchscreen of mobile phone 604 to input this request. At block 628, transaction apparatus 603 receives this request. At block 630, transaction apparatus 603 writes the information relating to the $50 credit (which was stored in memory at block 622) to a magnetic swipe card. User 2 may subsequently use this magnetic swipe card to enter into a transaction using the $50 credit.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method implemented by a computing device, wherein the computing device receives an offer to enter into a transaction, the method comprising steps of:
receiving information associated with a transaction;
storing, in a memory device, the information associated with a transaction;
receiving authentication information from a user to authenticate the user to enter into the transaction; and
enabling the user to enter into the transaction by using at least one of a magnetic swipe card writer, bar code display, or fingerprint reader.

2. The method of claim 1, wherein receiving information associated with a transaction comprises receiving the account information of another person.

3. The method of claim 1, wherein receiving information associated with a transaction comprises receiving a coupon for a purchase.

4. The method of claim 1, wherein receiving information associated with a transaction comprises receiving an electronic file.

5. The method of claim 1, wherein receiving information associated with a transaction comprises receiving information from a mobile computing device.

6. The method of claim 1, wherein receiving information associated with a transaction comprises receiving information from a computing system.

7. The method of claim 1, wherein receiving information associated with a transaction comprises receiving information from an apparatus operably connected to a mobile computing device.

8. The method of claim 1, wherein receiving authentication information from a user to authenticate the user to enter into the transaction comprises receiving information associated with the user's fingerprint.

9. The method of claim 1, wherein enabling the user to enter into the transaction by using at least one of a magnetic swipe card writer, bar code display, or fingerprint reader comprises writing the information associated with the transaction to a magnetic swipe card.

10. The method of claim 1, wherein enabling the user to enter into the transaction by using at least one of a magnetic swipe card writer, bar code display, or fingerprint reader comprises displaying the information associated with the transaction as a bar code.

11. The method of claim 1, wherein enabling the user to enter into the transaction by using at least one of a magnetic swipe card writer, bar code display, or fingerprint reader comprises displaying an electronic file after receiving the authentication information via a fingerprint reader.

12. The method of claim 1, wherein enabling the user to enter into the transaction comprises enabling the user to make a purchase.

13. The method of claim 1, wherein enabling the user to enter into the transaction comprises enabling the user to redeem a coupon.

14. The method of claim 1, wherein enabling the user to enter into the transaction comprises enabling the user to open an access-restricted electronic file.

15. The method of claim 1, wherein enabling the user to enter into the transaction comprises enabling the user to enter an access-restricted room.
